(19) United States
(12) Patent Application Publication
(10) Pub. No.: US 2010/0147094 A1
(43) Pub. Date: Jun. 17, 2010

(54) CENTERLESS ROBOTIC PLATFORM

(75) Inventor: Ami Kronenberg, Nesher (IL)

Correspondence Address: THE NATH LAW GROUP, 112 South West Street, Alexandria, VA, 22314, US

(73) Assignee: ORBITAL ROBOTICS LTD., Migdal HaEmek (IL)

(21) Appl. No.: 12/449,981

(22) PCT Filed: Mar. 6, 2008
(86) PCT No.: PCT/IL2008/000303

§ 371 Date: Sep. 4, 2009

Related U.S. Application Data
(60) Provisional application No. 60/905,327, filed on Mar. 7, 2007.

(51) Int. Cl. B25J 9/00; G06F 19/00; B25J 11/00

(52) U.S. Cl. 74/471 R; 74/479.01; 700/245; 901/2; 901/50; 901/41

(57) ABSTRACT

According to the present invention there is provided a Centerless Robotic Platform (CRP) system adapted for mounting on a surface of a body. The surface body extends along a longitudinal axis and having an essentially closed cross-sectional contour. The CRP system comprises at least a first drive unit comprising one or more rolling member, at least one link unit comprising one or more rolling member, and a biasing arrangement. The drive unit and the one or more link units are adapted for attachment to one another. When mounted onto the body, the biasing arrangement is adapted to bias the rolling members to engage the surface of the body. The biasing arrangement is adapted to urge the rolling members to dynamically follow the contour so as to maintain in surface contact with the surface during rotation of the system about the body

### FIELD OF THE INVENTION

This invention relates to pipe-work machinery, in particular, for marking, cutting, welding of pipes etc.

### BACKGROUND OF THE INVENTION

Pipes are generally hollow tubular bodies generally having a central axis about which the body of the pipe is disposed, defining an axial direction thereof. Pipes are employed in a wide variety of fields and implementations such as water and sewage infrastructure, irrigation, industrial plants etc.

There is always a need to cut away or weld portions of the pipe for various purposes such as joining an additional pipe thereto (in alignment or in intersecting relation therewith), creating an opening for removal of material from the pipe etc.

The cut-away/weld may be of various geometric shapes ranging from straight cutting of the pipe perpendicular to the central axis thereof, to elaborate shapes such as for transition bodies, connecting of pipes of different shapes and sized etc.

Although most such a cut-away/weld is easily and accurately performed on a 3D model of the pipe on a computer, performing a desired cut-away/weld in reality tends to prove more elaborate due to the inaccuracy resulting both from manual marking of a cut-away/welding line as well as manually performing the cut-away/welding operations.

One type of devices suggested for performing the above operations are adapted to be mounted onto the pipe and perform a rotary motion about the central axis thereof so as to cut a portion of the pipe perpendicular to the central axis, such as disclosed in U.S. Pat. No. 5,227,601 etc.

Another type of devices further comprises an additional cutting assembly wherein the device is adapted to be mounted onto the pipe and while performing rotary motion about the central axis thereof, an operator may displace a part of the cutting assembly in the axial direction of the pipe to perform the desired cutting/welding operations. One example of such a device is disclosed in U.S. Pat. No. 5,159,756.

For the purpose of mounting the device onto the pipe, several devices have been contemplated having a chain like design, allowing mounting of the device onto a pipe of desired diameter and tightening of the device around the pipe in a secure fashion. One example of such a device is disclosed in U.S. Pat. No. 3,763,559.

### SUMMARY OF THE INVENTION

According to, the present invention there is provided a Centerless Robotic Platform (CRP) system adapted for mounting on a surface of a body extending along a longitudinal axis, said body having an essentially closed cross-sectional contour, said system comprising:
at least a first drive unit comprising one or more rolling member;
at least one link unit comprising one or more rolling member; and
a biasing arrangement;

wherein said drive unit and said one or more link units are adapted for attachment to one another, and wherein, when mounted onto said body, said biasing arrangement is adapted to bias the rolling members to engage the surface of said body; Said biasing arrangement being adapted to urge said rolling members to dynamically follow said contour so as to maintain in surface contact with said surface during rotation of said system about said body.

The drive unit and link unit are optionally modularly attached to one another in an in-line manner to form an element constituted by a plurality of coextending units.

The CRP system may further comprise a manipulator assembly comprising a manipulator arm fitted with a replaceable manipulator module chosen according to the desired operation such as cutting, welding, marking, scanning etc, and an actuator for said manipulator arm. Said actuator is adapted to impart to the manipulator arm a reciprocal motion in a direction parallel to the longitudinal axis of said body, or inclined with respect thereto, whereby the combined arrangement of rotary motion of the CRP system and axial movement of the manipulator arm may allow said manipulator module to reach any desired location on the external/internal surface of the body, depending on the manner of mounting the CRP system thereto.

The body onto which said CRP system is adapted to be mounted may be a solid body or a hollow body. In the former case, said surface is the external surface of the body and said CRP system is adapted to be mounted on said external. Examples of such a body may be poles, tree trunks, etc. In the latter case, said surface may either be the external surface or the internal surface of said body, and said CRP system is adapted to be mounted either onto said external surface or on said internal surface within the hollow body. Examples of hollow bodies may be pipes, tubes, chimneys etc.

Said closed cross-sectional contour may be of essentially round shape having a variety of possible shapes such as circular, oval, elliptic, or any other round shape, however devoid of significant negative radii along the circumference thereof. The term ‘negative radii’ refers to a mathematical definition concerning a contour in which the center of one or more of the circles, the arcs of which form the contour, is located outside the contour.

Said drive unit may comprise a main body having a lead end and a tail end, and formed with two sets of rolling members disposed at the corresponding lead and tail ends thereof. Said drive unit may comprise a drive motor adapted for imparting rotary motion to said rolling members so as to cause the CRP system to perform a rotary motion about the body; and a manipulator motor adapted for activation of the actuator.

Said drive motor and manipulator motor may transfer power to the rolling members and/or manipulator arm using belt/chain mechanisms, gear transmissions or any combinations thereof, etc.

Said drive unit may also be provided with a controller adapted for regulating the operation of the entire CRP system including rotary motion of the CRP system about the body, operation of the actuator, operational modes of the manipulator module, etc. In particular, said controller is adapted for controlling the operation of both said drive motor and said manipulator motor, as well as the operation of the manipulator module. Said controller may in turn be connected to a control center, which may be a lap top computer, a PDA device, a hand-held etc., and may be fully interfaced with a CAD/CAM software found on the lap top computer providing the controller with required data to operate the drive and manipulator motors.

Said drive unit may further comprise a set of attachment ports located at the lead and tail ends thereof, said attachment ports being adapted for attaching thereto a link unit and/or said biasing arrangement. Said attachment ports may be, for example, in the form of recesses adapted to receive therein a connecting axle. It should be noted that said drive unit may be of essentially symmetric design wherein the lead and tail ends thereof are functionally interchangeable.

Said link unit may comprise a main body having a lead end and a tail end, and may be formed with at least one set of rolling members adapted to come in contact with the surface of said body when mounted thereon. Said link unit may be further formed With two sets of attachment ports formed at a lead and a tail end of the body, adapted for attachment to said drive unit and/or additional link units.

The link unit may further comprise a drive transfer mechanism adapted to transfer drive to the rolling member of said link unit from an adjacent unit connected thereto. For example, said drive transfer mechanism may comprise a sprocket articulated to the rolling member of the link unit by a drive belt.

Said biasing arrangement may be in the form of a biasing unit having a lead end and a tail end. Said biasing unit may comprise a body formed with a first set of attachment ports at a lead end thereof, and an extendable platform the end of which forms the tail end of said biasing unit, and formed with a second set of attachment ports. Said biasing unit is designed such that said extendable platform are adapted to be deployed and retracted such that said extendable platform projects from the main body, thereby effectively increasing/decreasing the distance between the first set of attachment ports and the second set of attachment ports. Such an arrangement allows shortening or elongating the entire biasing unit.

Said extendable platform may be formed with a first, regulated extendable member which may be articulated to the main body in a manner allowing fixation thereof in one of a plurality of positions, and a second, dynamic extendable member dynamically articulated to said regulated extendable member in a manner allowing displacement with respect thereto under application of external forces thereto. According to such an arrangement, said dynamic extendable member is formed with said second set of attachment ports.

Thus, said regulated extendable member may be fixed at a desired position with respect to said main body, defining a fixed distance between a first end of said regulated extendable member and the lead end of said main body. However, dynamic displacement of said dynamic extendable member with respect to said regulated extendable member provides that for each position of said regulated extendable member, there exists a range of distances between said first and said second set of attachment ports.

According to a specific design variation, said regulated extendable member may be in the form of two longitudinal gear racks, which are articulated to the main body by a gear mechanism including a regulation cog. Said gear mechanism is designed such that rotation of the regulation cog entails deployment or retraction of the gear racks to project from the body of the biasing unit to the same extent and to the same direction.

Each of said gear rack may be formed with formed with a channel adapted to receive therethrough a projecting rod constituting said dynamic extendable member. Each projecting rod may be formed with a flange at one end thereof and a connecting portion at a second end thereof formed with said set of attachment ports. In assembly, the arrangement is such that when received within the gear rack, each projecting rod is fitted with a compression spring mounted thereon and compressed between said flange and a second end of said gear rack.

In assembly, a desired number of link units is first chosen according to the girth of the body onto which said CRP system is to be mounted. Thereafter, the drive unit, link units and biasing unit are consecutively connected to one another, lead end to tail end, to form a chain-like arrangement.

When connecting any two of the above units to one another, a connecting member, for example a connecting axle, is passed through the attachment ports formed at a lead end of one unit and the attachment ports formed at a tail end of an adjacent unit such that the two units become pivotally articulated to one another, having a mutual axis defined by the connecting axle.

In particular, when two link units, or a link unit and said drive unit are interconnected, said connecting axle may comprise an idler wheel adapted to mesh with both a rolling member of one unit and the drive transfer mechanism of the adjacent unit. The idler wheel is adapted to ensure that all rolling members rotate in the same direction upon operation of the driving motor as will be explained in detail later. Thus, the idler wheel shares a mutual axis with said connecting axle, and consequently the mutual pivot axis between two consecutive units. It should be stressed out that according to various design variations, said idler wheel may also be a part of said drive unit or even a part of said drive transfer mechanism.

Thereafter, the lead end and tail end of the chain-like arrangement are attached to the attachment ports of the biasing unit to form a closed loop. In particular, the lead end may be attached to the attachment ports formed in the main body of the biasing unit and the tail end may be attached to the ports formed in the extendable platform and vise versa. Such an arrangement provides that the length of the loop may be adjustable by the regulation cog of the biasing unit while still maintaining a dynamic length allowing the CRP system to adjust to a variety of round shapes as previously discussed as well as irregularities on the surface of the body, for example bulges etc.

However, it should be understood that the connection between two adjacent units is referred to above as being pivotal, it may optionally be a rigid connection, forming a substantially rigid construction. In such case, the biasing arrangement may provide the wheels of the units with the necessary degree of freedom so as to dynamically follow the contour of the surface of the body.

In its assembled position as described above, the CRP system may be sufficiently light so as to be portable by a single operator.

In preparation, when the assembled CRP system is mounted onto the pipe, the arrangement is such that the CRP system aligns itself to become perpendicular to the longitudinal axis of the pipe. In a mounted position, the rolling members of the CRP system have their axes essentially parallel to the longitudinal axis and are adapted for rotary motion about the circumference of the pipe. The regulation cog is then used to tighten the CRP system about the pipe such that all rolling members come in surface contact with the external/internal surface of the pipe.

It should be stressed out that the regulation cog is adapted for maintaining a fixed position only of the gear racks, wherein the projecting rods are free to displace therein under the biasing force of the compression spring so as to provide a degree of freedom determined by the compression coefficient of said spring.

Thus, when said CRP system is mounted onto a body which is not of a circular cross section, or a body having a non-uniform surface, said CRP system is adapted to snugly expand and contract about the body so as to ensure that all rolling members come in surface contact with the external surface of the body. It should be noted that the degree of freedom provided by the compression spring of the extendable platform also facilitates overcoming bulges on the surface of the body, changes in diameter, e.g. change in cross-section, irregularities etc.

The following example refers to cutting a pipe, however, it should be understood that a variety of other operations may be performed by the CRP system as indicated before, and further including painting, coating, corrosive treatment etc. For each of theses operations, a different manipulator module may be used.

Further in preparation, a desired program is loaded to the control center, e.g. laptop, the laptop is connected to the controller and an origin point for the operation is selected. Such a program may be, for example, a 3D model of pipe having a cut-away for connection of an intersecting pipe thereto. It should be pointed out that, unlike the complex and intricate production of such a cut-away in a manual fashion, producing the same on a 3D CAD/CAM software is a standard and simple operation.

At a final stage of preparation, a desired manipulator module is chosen and mounted onto the manipulator arm.

In operation, the controller receives from the control center the required data regarding the shape, size and orientation of the contour of the cut-away to be opened on the envelope of the pipe. Following this data, the controller will generate a signal to the CRP system to perform a rotary motion about the pipe while simultaneously commanding the manipulator arm to reciprocate such that the manipulator module follows the exact contour as produced by the CAD/CAM software.

It is noted that according to the CRP system previously described, when performing a rotary motion about the pipe, torque from the drive unit is passed via the idler wheels to all the link units, whereby all units (accept the biasing unit) may be considered to be driven. In other words, the rolling members of the link unit don't progress on the external surface of the pipe merely due to the pulling caused by the movement of the drive unit. Rather, the rolling members of all units are driven, thereby providing better traction, better compression to traction ration etc.

It should further be understood that once positioned at a desired location along the longitudinal axis of the body, the CRP system is completely self-sufficient and controlled automatically by the control center, thereby eliminating the need for intervention of an operator.

Although the above design is securely mounted onto the pipe, occasionally, said rolling members may slip on the outer surface of the pipe. For example, if the wheels with are covered with an elastomeric material to improve traction, when rolling on a hard surface a certain amount of slippage still takes place. This amount is not completely predictable and therefor feed-back about the real amount of motion is needed in operations that demand accuracy.

For this purpose, said CRP system may further be provided with an encoder adapted to alert the controller of any such slippage and indicated the controller to take corrective action. Such an arrangement allows the controller to make sure that the manipulator module indeed follows the contour dictated by the CAD/CAM software.

As previously mentioned, said CRP system may be adapted to perform additional operations, requiring different manipulator module. Such operations may be any the following:

Marking—prior to performing a cutting operation using a CRP system, a marking head may be mounted onto the manipulator arm and produce a marked outline of the cut-away to be cut or welded. Thereafter, said CRP may follow said marked outline. Alternatively, once marked, an operator may manually perform said cut-away;

Welding—two bodies may be welded to one another using a welding head in a manner similar to that described with respect to cutting; and

Scanning/inspecting—said manipulator module may be equipped with an optical arrangement (camera, X-Ray etc.) allowing scanning of the internal/external surface of the pipe.

According to a specific design, said CRP is designed such that the orientation thereof may be changed, i.e. the axes of the rolling members may be angled to the longitudinal axis. Such an arrangement may provide the CRP with a spiral movement allowing it to progress along the pipe. Such a mode of operation may allow performing some of the following operations:

Painting/coating—said manipulator module may be provided with fluid connection with a paint storage, wherein during rotation of the CRP system, a pipe may be uniformly painted; and

Corrosive treatment—said manipulator module may be adapted for performing anti-corrosive operations, applying an anti-corrosive layer etc.

In such a configuration, the CRP system may even be used for applications as specified below:
Bough trimming—The CRP system may be mounted on a tree trunk and fitted with an appropriate cutting manipulator module allowing the CRP system to trim the boughs of a tree;
Spreading/Fertilizing—The CRP system may be used with a spreading module attached to a storage of spreadable material;
Scraping/Cleaning—The CRP system may be fitted with a scraper manipulator module adapted to clean the internal or external surface of a pipe; and
Picking—The CRP system may be fitted with a storage compartment and said manipulator module may be adapted to remove material or item from locations along the body and displace them into said storage compartment.

Various operation modes of the CRP may be employed as described below:
The CRP system may be adapted to operate from the inside of a pipe. In such a case, the projecting rods of said biasing unit may be reversed to allow the previously employed compression spring to become a tension spring, whereby, when mounted into a pipe the biasing arrangement increases the length of the CRP system to allow all rolling members to come in contact with the internal surface of said pipe;
The CRP system may be adapted to be mounted onto bodies oriented such that the longitudinal axis thereof is not parallel to the ground. The CRP system as described above may even provide enough traction to allow said system to be securely mounted onto vertically oriented bodies, i.e. having their longitudinal axis perpendicular to the ground. Such bodies may be for example, poles, chimneys, columns, vertical pipes etc.
The CRP system may comprise several drive units, all controlled by the same controller. Such an arrangement may provide greater driving power and substantially better tractions;
The manipulator module may also be equipped with a gravitational indicator providing information to the controller regarding the orientation of the manipulator module. The controller may then be adapted to choose the appropriate operational mode for the manipulator module. For example, when working upside down, i.e. on the bottom side of a pipe, in case of welding, the operational parameters are different that those used when working on the top side of the pipe. Such parameters may be controller by the controller;
The manipulator motor may be adapted to rotate the manipulator arm about the central axis thereof to change the orientation of the manipulator module, thus allowing it to perform operations at virtually any desired angle; and
The link units may also be fitted with a manipulator motor and a manipulator arm, whereby said CRP system may comprise more than one manipulator arm. This may be particularly useful in welding, wherein two counterpart manipulator arms may be used to provide a more balanced welding. In this case, the CRP system optionally comprises more than one controller, wherein each controller is in charge of a different manipulator arm. According to a specific design variation, one of the controllers may be programmed to be a ‘master’ controller and the others to be ‘slave’ controllers;
All units may be motor driven. The motors may be servo motors, the operation of which is coordinated by the controller.

### BRIEF DESCRIPTION OF THE DRAWINGS

In order to understand the invention and to see how it may be carried out in practice, embodiments will now be described, by way of non-limiting examples only, with reference to the accompanying drawings, in which:

FIGS. 1A and 1B are schematic front and side views showing the geometry of a pipe and a system of wheels mounted thereon;

FIG. 2 is a schematic isometric view of the CRP system according to the present invention at its open position;

FIG. 3A is a general schematic isometric view of a drive unit used in the CRP system shown in FIG. 2;

FIG. 3B is a detailed schematic isometric view of a drive unit used in the CRP system shown in FIG. 2, with the cover thereof removed;

FIG. 4A is a general schematic isometric view of a link unit used in the CRP system shown in FIG. 2;

FIG. 4B is a schematic isometric view of a link unit used in the CRP system shown in FIG. 2, with the cover thereof removed;

FIG. 4C is a detailed schematic isometric view of a prolonged link unit used in the CRP system shown in FIG. 2, with the cover thereof removed, according to another embodiment of the present invention;

FIG. 5A is a general schematic isometric view of a biasing unit used in the CRP system shown in FIG. 2;

FIG. 5B is a detailed schematic isometric view of a biasing unit used in the CRP system shown in FIG. 2, with its cover removed;

FIG. 6A is a schematic front view of the drive unit shown in FIG. 3B when connected on both sides thereof to a link unit shown in FIG. 4A;

FIG. 6B is a schematic back isometric view of the drive unit and link units shown in FIG. 6A;

FIG. 7 is a schematic isometric view of a manipulator mechanism used in the CRP system according to the present invention;

FIG. 8 is a schematic isometric view of the CRP system shown in FIG. 1 when mounted onto a pipe;

FIGS. 9A to 9C are schematic isometric, front and side views respectively of a pipe with a cut away produced by the CRP system of the present invention;

FIG. 10 is a schematic front view of the CRP system shown in FIG. 2 when mounted within a hollow pipe; and

FIG. 11 is a schematic side view showing the basic geometry of the wheels of the CRP system according to an embodiment of the present invention;

### DETAILED DESCRIPTION OF EMBODIMENTS

### Geometric Configuration

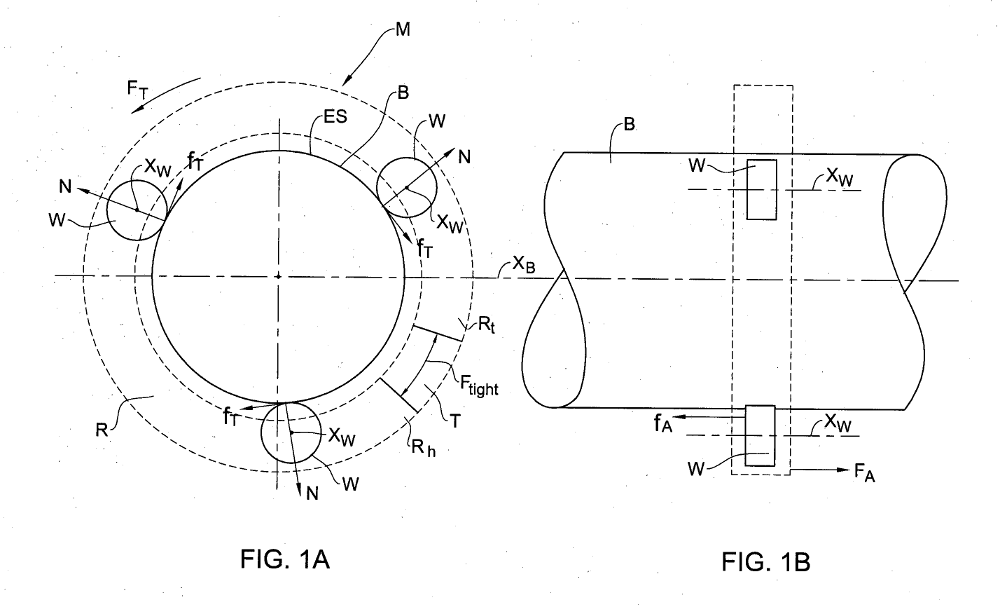

Turning to FIGS. 1A and 1B, a substantially cylindrical body generally designated B is shown having mounted thereon with a mechanism generally designated M comprising a ringed body R and three wheels W which are substantially equally angularly disposed, and are in contact with the external surface ES of the body B. The wheels W are arranges such that the axis of rotation thereof. X_{W} is essentially parallel to the longitudinal axis X_{B} of the body B. Uniform pressure is applied to the wheels W in a direction normal to the external surface ES so as to retain them in place.

With particular reference to FIG. 1A, when rotating the mechanism M about the body B, a tangential force F_{T} is required to overcome tangential friction h. The friction f_{T} is calculated by the following formula: f_{T}=N·μ, where N is the normal force applied on the external surface ES by the wheels W and μ is the friction coefficient between the wheels W and the external surface ES. This coefficient depends on the materials out of which the wheels W and the external surface ES of the body B are made.

Turning to FIG. 1B, when trying to move the mechanism M along the longitudinal axis of the body B, an axial force F_{A} is required to overcome axial to friction f_{A}. The friction f_{A} is calculated by the following formula: f_{A}=N·μ. However, it should be appreciated that although μ remains the same, since the wheels W don't perform a rotary motion about the body B, the axial friction f_{A} requires much greater force F_{A} to perform the axial movement.

In the provided arrangement, during rotation about the body B, and provided no axial forces greater than F_{A} act on the mechanism, the mechanism M will remain in the same axial position with respect to the body B due to the friction force f_{A}.

Reverting to FIG. 1A, the ring R of the mechanism M is provided with a tightening unit T adapted to apply a tightening force F_{tight} by decreasing the distance between the head and tail ends Rₕ and Rₜ of the ring R respectively, thereby increasing the normal force N, and consequently the friction forces f_{T} and f_{A}. The ratio between the tightening force and the normal force depends on the amount of wheels W, for example, in case six wheels are used, on unit of tightening force F_{light} yields and increase of six times the normal force N. This calculation is broadly based on the assumption that the wheels W are equally spaced about the perimeter of the body B.

It should also be emphasized that the above model is based on rolling action of the wheels W, in which case the static coefficient of friction is the dominant parameter. In special tasks in which the wheels are adapted to roll on bodies having a varying curvature, a high rate of slippage is expected. In such cases special care is taken to minimize the effects of dynamic coefficient of friction.

General Description of System Components

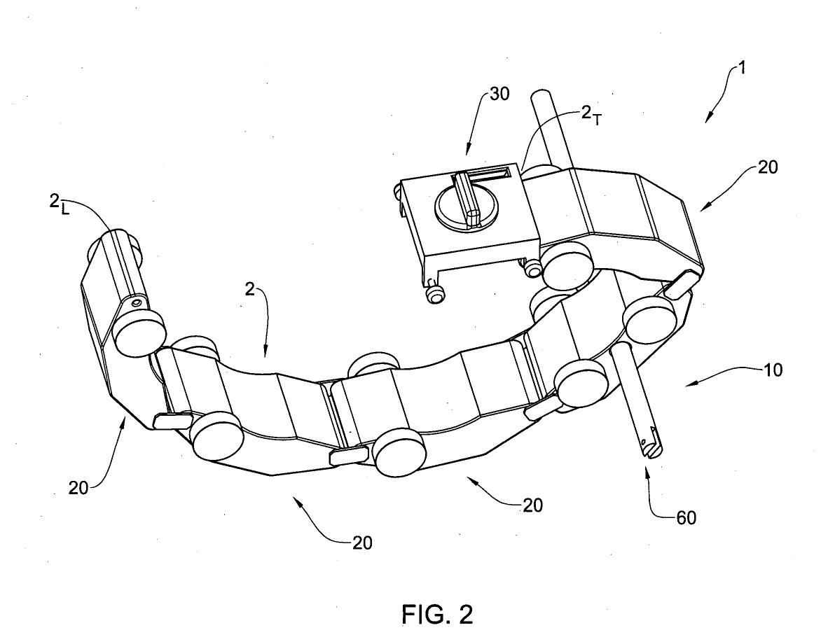

Turning now to FIGS. 2 to 5, a centerless robotic platform (CRP) system, generally designated 1 is shown comprising a drive unit 10, four link units 20, and a biasing arrangement 30, all interconnected therebetween to form a chain-like arrangement. The CRP system 1 further comprises a manipulator mechanism 60 adapted to perform operations on a body as will be described in detail later.

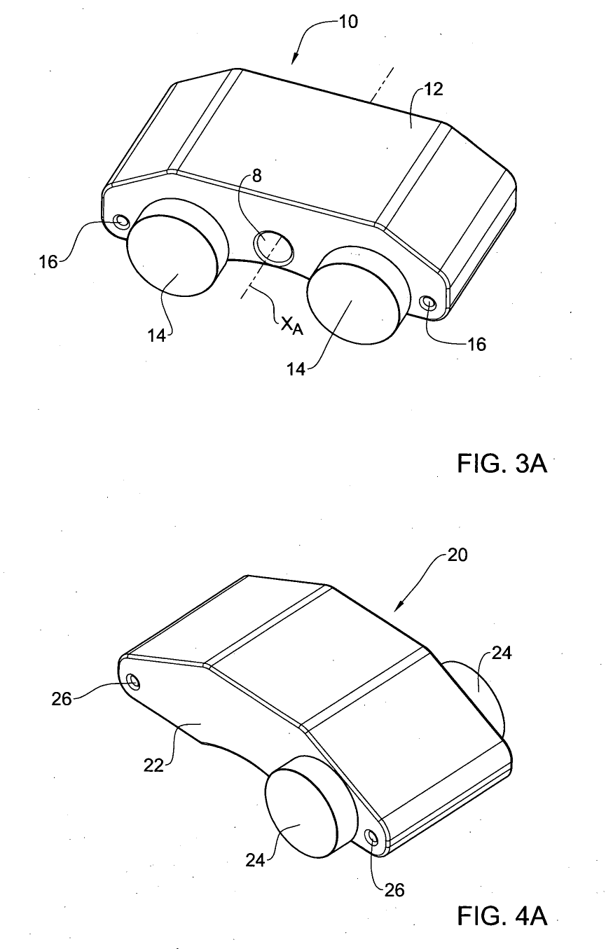

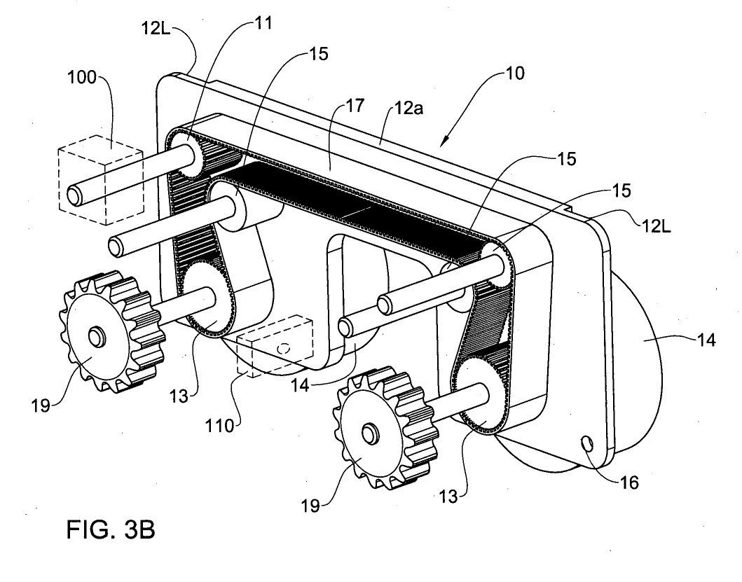

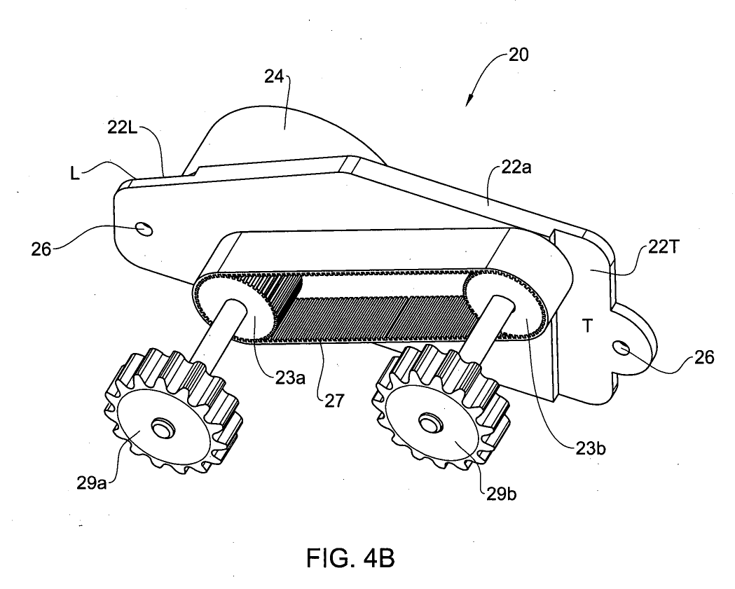

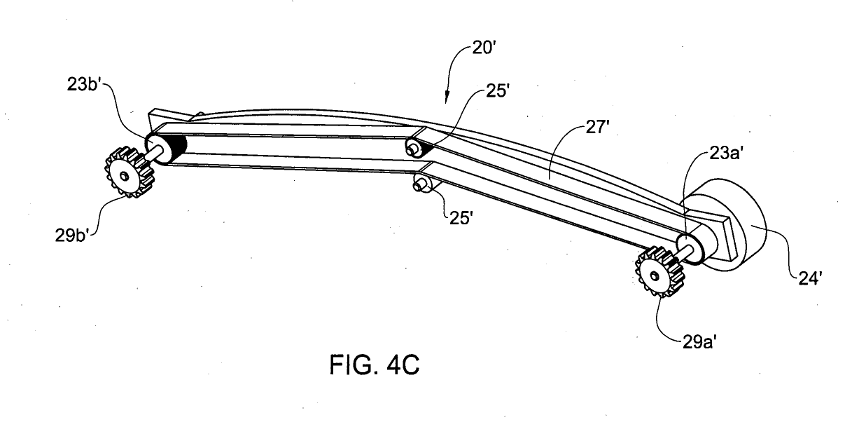

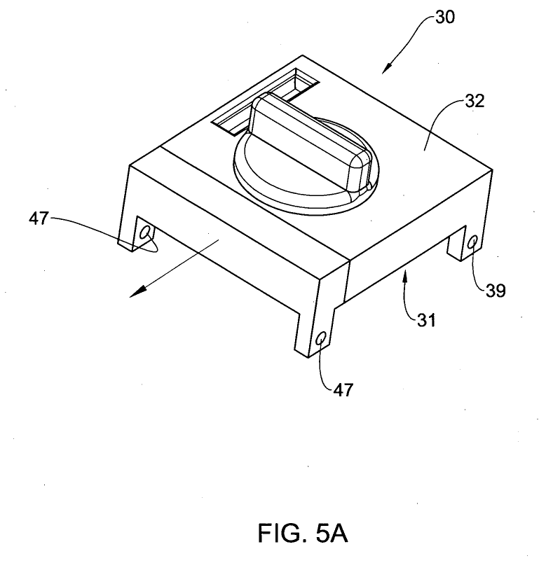

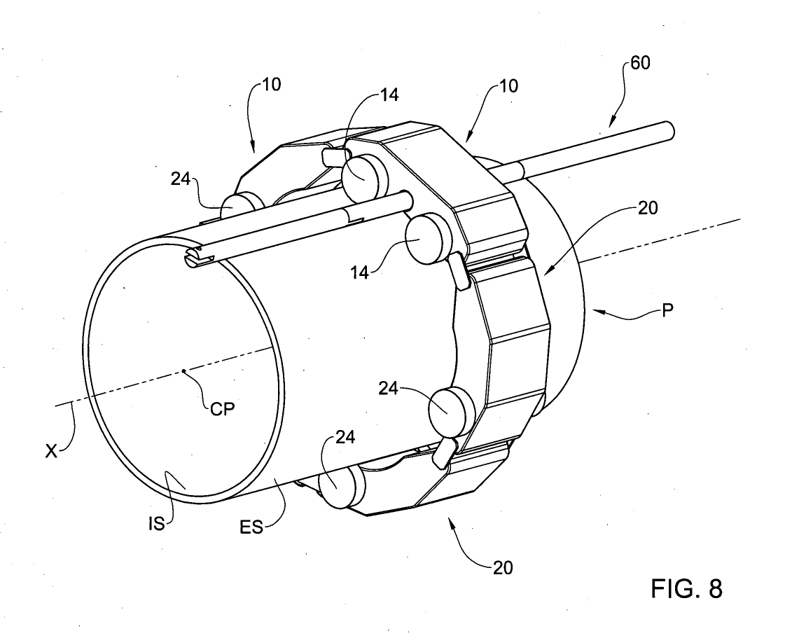

The drive unit 10 comprises a body 12 (shown FIG. 3A), two sets of two wheels 14 each, disposed at respective ends of the body 12, and two pairs of attachment ports 16 formed at the ends of the body 12, adapted to receive connecting elements 70 therethrough. The drive unit 10 further comprises a drive motor (schematically shown FIG. 4B) articulated to the wheels 14 and adapted to provide them with a required drive. The drive unit 10 is further formed with a manipulator arm actuator port 18 defining an auxiliary axis Xa, and adapted to receive therethrough a manipulator arm 50 (shown FIG. 7).

Each link unit 20 (shown FIG. 4A) comprises a body 22, one set of two wheels 24, disposed at one end of the body 22, and two pairs of attachment ports 26 formed at respective ends of the body 22, adapted to receive connecting elements 70 therethrough. As will be described in detail later, the link unit 20 is adapted to be driven by the drive motor of the drive unit 10. However, according to a specific design variation, the link unit 20 may also comprise a drive motor of its own.

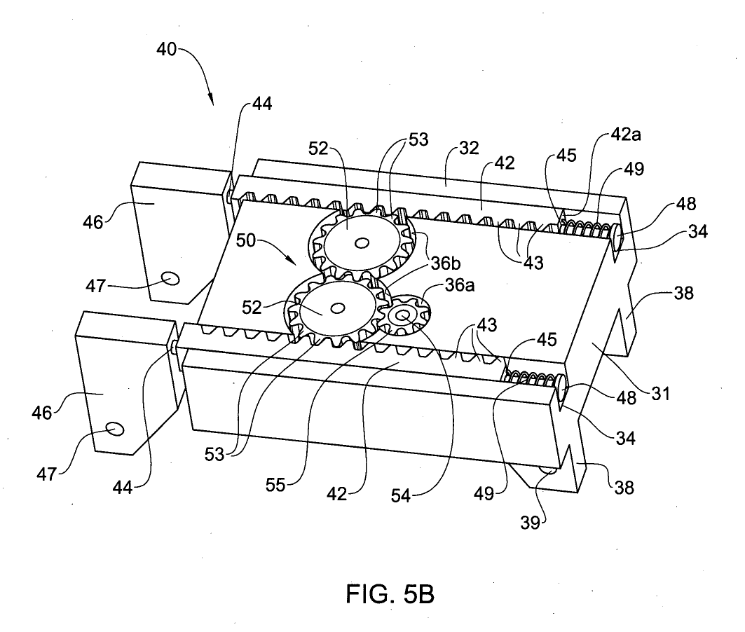

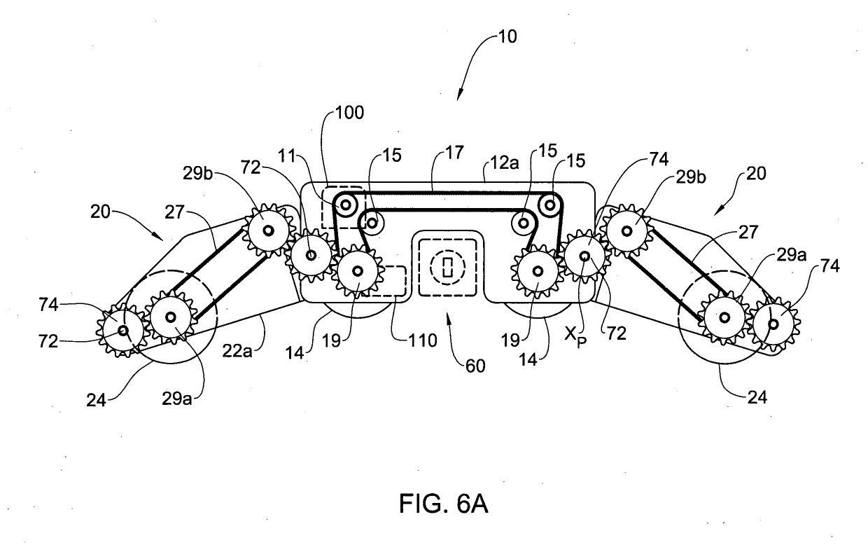

The biasing arrangement 30 (shown FIG. 5A) functions as a biasing unit 31 and is fitted with a biasing arrangement (40, 50 shown FIG. 58). Said biasing unit 31 is further formed with a first set of attachment ports 39 and a second set of attachment ports 47, and is designed to change its dimension so as to allow regulation of the distance between the first set of attachment ports 39 and the second set of attachment ports 47.

General Description of System Assembly

In assembly (FIG. 2), the drive unit 10 and a desired number of link units 20 are consecutively attached to one another to form a chain-like construction 2 having a lead end 2_{L} and a tail end 2_{T}: The number of units 10, 20 is determined according to the dimensions of the body onto which the system 1 is to be mounted. Each two adjacent units 10, 20 are pivotally articulated to one another by a connecting element 70 having a central axis, such that the attachment ports 16, 26 of each two adjacent units 10, 20 are aligned on a mutual pivot axis Xₚ.

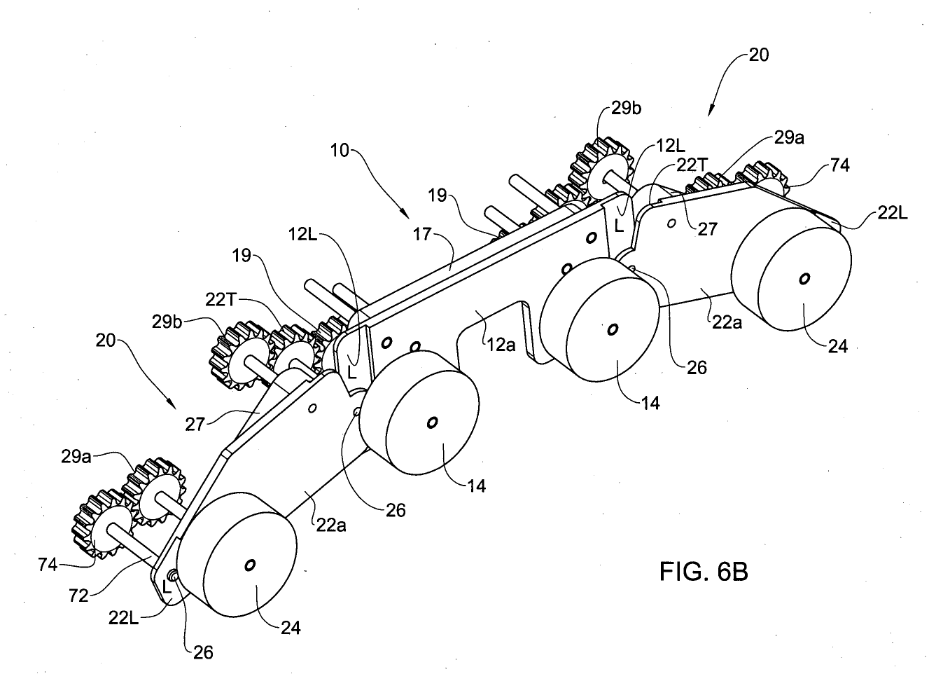

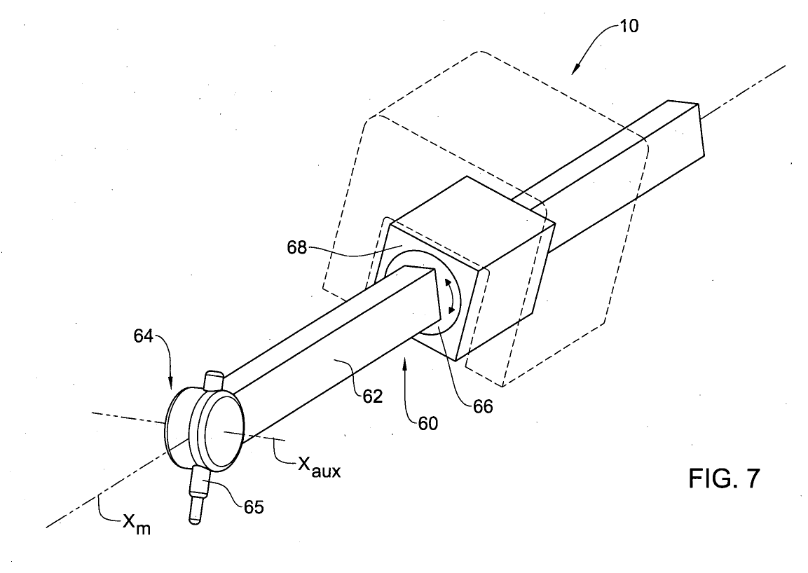

As will be explained in detail later with reference to FIG. 6, the units are articulated to one another such that the torque generated by the drive unit 10 is transmitted to all the other link units 20, for example by means of a gear mechanism.

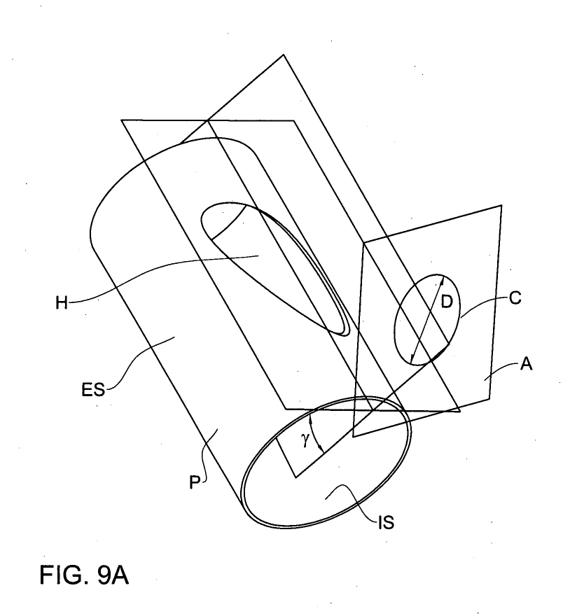

Thereafter, the biasing unit 31 is attached to the lead end 2_{L}, and tail end 2_{T} of the chain-like construction 2 to form a closed loop (shown FIG. 8). The biasing unit 31 provides regulation of the overall perimeter of the loop by its ability to change the distance between the attachment ports 39, 47. Therefore, when mounting the system 1 onto an external perimeter surface of a body, for example a pipe, the chain-like construction may be tightened around the pipe to provide the desired traction between the wheels 14, 24 of the units 10, 20 and the external surface ES of the pipe.

It should be appreciated that such an arrangement, when mounted on a body having a closed cross-sectional contour, for example, circular, oval, elliptic etc, provides that the entire system 1 is urges to dispose around a geometric center point CP (shown FIG. 8). The center point CP however, may change its location due to the shape of the cross section.

After assembling the system 1, the drive unit 1 may be provided with the manipulator arm 50 (FIG. 7) through the channel 18, and the manipulator arm 50 is then fitted with a desired operation head 60.

Detailed Description of the Drive Unit

Turning now to FIG. 3B, a drive unit 10 is shown with the cover removed to reveal the internal construction thereof. The drive unit 10 comprises a back panel 12a, a drive gear 11 driven by the motor 100 (schematically represented), two wheel gears 13 attached to the wheels 14, and a set of tension wheels 15, adapted for mounting thereon a drive belt 17. The drive unit 10 also comprises a set of sprockets 19 sharing a mutual axis with the wheels 14 and the wheels gears 13, and adapted for connection to link units 20 or the biasing unit 31 connected thereto.

The back panel 12a is formed with a two lead steps 12L at respective ends thereof. The lead steps 12L are formed as recessed surfaces L at rear sides of the back panel 12a. Each of the lead steps 12L is formed with an attachment port 16. Thus, the drive unit 10 may be attached to a link unit 20, lead step 12L to tail step 22T, such that the respective lead and tail surfaces L, T are in contact with one another.

Detailed Description of the Link Unit

With reference to FIG. 4B, a link unit 20 is shown with the cover removed to reveal the internal construction thereof. The link unit 20 comprises a back panel 22, a wheel gear 23a attached to the wheel 24, and a transfer gear 23b. A drive belt 27 is mounted onto the wheel gear 23a and transfer gear 23b to constitute a drive transfer mechanism. The link unit 20 also comprises a set of sprockets 29a, 29b attached to the wheel gear 23a and transfer fear 23b, sharing a respective mutual axis therewith, and adapted for transferring drive to additional link units 20 or the biasing unit 31 connected thereto.

The back panel 22a is formed with a lead step 22L and a tail step 22T at respective ends thereof. The lead step 22L is formed as a recessed surface L at a rear side of the back panel 22a, and the tail step 22T is formed as a recessed surface T at a front side of the back panel 22a. The lead step 22L and the tail step 22T are each formed with an attachment port 26. Thus, two similar link units 20 may be attached to one another, lead step 22L to tail step 22T, such that the respective lead and tail surfaces L, T are in contact with one another.

### Additional Embodiment of a Link Unit

With reference to FIG. 4C, an elongated link unit 20′ is shown with its cover removed. Such an elongated link unit 20′ may be used for pipes having a large diameter. The link unit 20′ comprises a wheel gear 23a′ attached to the wheel 24′, a transfer gear 23b′, and a set of tension wheels 25′. A drive belt 27′ is mounted onto the wheel gear 23a′, transfer gear 23b′ and tensions wheels 25′ to constitute a drive transfer mechanism. The link unit 20′ also comprises a set of sprockets 29a′, 29b′ sharing a mutual axis with the wheel gear 23′ and the transfer gear 23b′ and adapted for connection to link units 20′ or the biasing unit 31 connected thereto.

Detailed Description of the Biasing Arrangement

Turning to FIG. 5B, the biasing arrangement 30 is shown to be in the form a biasing unit 31 and comprises a main body 32 formed with a pair of rack receiving slots 34, a regulation cog recess 36a and two rack cog recesses 36b. The biasing unit 31 is further formed with two projections 38 formed with a set of attachment ports 39. The biasing unit 31 is fitted with a biasing mechanism Comprising an extendable platform 40 and a gear mechanism 50.

The extendable platform 40 comprises a set of regulated extendable members in the form of two gear racks 42, and a set of dynamic extendable members in the form of two projecting rods 44. Each gear rack 42 is formed with gear teeth 43 and a central channel 45. Each projecting rod 44 is formed at one end with a connecting portion 46, formed in turn with a pair of attachment ports 47, and at the other end with a flange 48.

Each projecting rod 44 is received within a respective channel 45 of the rack gear 42, and is fitted with a biasing spring 49 compressed between the flange 48 and an end 42a of the gear rack 42. Such an arrangement allows said projecting rod 44 to displace within the channel 45 depending on the coefficient of the biasing spring 49.

The gear mechanism 50 comprises a pair of rack cogs 52 having teeth 53, and a regulation cog 54 having gear teeth 55.

In assembly of the biasing unit 31 the entire extendable mechanism 40 is received within the rack receiving slots 34 oldie biasing unit 31. The two rack cogs 52 are received within the rack cog recesses 36b of the biasing unit 31 such that the teeth 53 thereof mesh with each other, and with the teeth 43 of the respective gear rack 42 of the extendable mechanism 40. The regulation cog 54 is received within the regulation cog recess 36a such that the teeth 55 thereof mesh with the teeth 53 of one of the rack cogs 52.

In operation of the above described arrangement, when turning the regulation cog 54, the gear racks 42 are urged to deploy/retract from the biasing unit 31 such that the end thereof projects from the biasing unit 31. Once the desired deployment position of the gear racks 42 is established, the projecting rods 44 may still displace within the channel 45 of the gear racks 42; thereby allowing the connecting portion 46, and consequently the attachment ports 47 to assume a range of distances from the attachment ports 39 of the biasing unit 31.

Detailed Description of Assembly

Turning now to FIGS. 6A and 6B, the manner of connecting the units 10, 20 to one another is demonstrated. The drive unit 10 and a link unit 20 attached lead step 12L to tail step 22T, such that the respective lead and tail surfaces L, T are in contact with one another. The drive unit 10 and link unit 20 are connected by mutual connecting axle 72 passing through the attachment ports 16, 26 thereof. This arrangement provides that each two consecutive units share a mutual pivot axis Xₚ. The connecting axle 72 is fitted with an idler wheel 74 adapted to mesh on one hand with the sprocket 19 of the drive unit 10 and on the other hand with the sprocket 29 of the link unit 20.

Thus, operation of the drive motor of the drive unit 10 imparts a rotary motion to the wheels 14, which is consequently passed to the sprocket 19. The sprocket 19, being meshed with the idler wheel 74, causes rotation thereof, which is transferred to the sprocket 29 of the link unit 20. Thus, the link unit 20 is driven by the drive motor of the drive unit 10.

However, it should be understood that the connection between two adjacent units is referred to above as being pivotal, may optionally be a rigid connection, forming a substantially rigid ring R such as shown in FIGS. 1A and 1B. In such case, a biasing arrangement of different design may be employed providing the wheels 14; 24 of the units 10, 20 respectively with the desired degree of freedom so as to dynamically follow the contour of the surface of the body B.

Detailed Description of the Manipulator Assembly

Turning to FIG. 7, a manipulator assembly, generally designated 60 is shown comprising a manipulator arm 62 fitted with a manipulator module 64. The manipulator arm 62 is received within an actuator 66 facilitating reciprocal displacement of the manipulator arm 62 along the longitudinal axis thereof. The actuator 66 in turn is housed within an actuator housing 68, adapted to rotate the actuator about the longitudinal axis Xₘ.

The manipulator module 64 is replaceable, and may be chosen from a wide variety of modules adapted for welding, cutting, marking, scanning etc. The manipulator module 64 itself comprises an auxiliary arm 65 adapted to perform a rotary motion about an auxiliary axis Xₐᵤₓ.

In assembly, the actuator housing 68 is received within the drive unit 10 and is connected to the control motor which is responsible for both the reciprocal and rotary motion of the manipulator arm 62.

Thus, in operation, the tip of the auxiliary arm 65, which may be, for example, a plasma cutting head, is capable of selectively reaching any desired location and angle on the pipe.

Preparation

Turning now to FIG. 8, When the CRP system 1 is to be used to perform a desired operation on a pipe P, the system 1 is first mounted onto the pipe P at a desired location and the biasing arrangement 30 is used to tighten the CRP system 1 about the pipe P. In this position all the wheels 14, 24 of the drive unit 10 and the link unit 20 respectively come in surface contact with the external surface ES of the pipe and the CRP system 1 is considered to be secured to the pipe P. The term secured should also be understood such that the CRP system 1 is tensioned on the pipe P so as to prevent disengagement therefrom even if the pipe P is brought to a vertical position.

The desired location is determined as an initial point referring to coordinates of the body set by an operator to thereby define an origin point, i.e. origin coordinates.

It should also be noted that a tightening to traction ratio λ may be defined denoting the change in traction force (F_{Trac}) resulting from compression of the spring by a unit force (F_{Comp}), i.e.

$$λ = \frac{{F}_{Comp}}{{F}_{Trac}} .$$

For example, in a particular configuration, the ration λ may be equal to six, wherein turning the regulation cog to apply a force of 1 N to said compression spring will produce traction of about 6 N on each rolling member. It should also be noted that traction is imperative for securely maintaining the CRP system on the pipe.

Thereafter, a desired manipulator module 64 is fitted to the manipulator arm 62, according to the desired operation.

At a final stage of preparation, the drive motor, manipulator motor and manipulator module 64 of the CRP system are connected to a power source, and the controller is connected to the control center.

General Operation

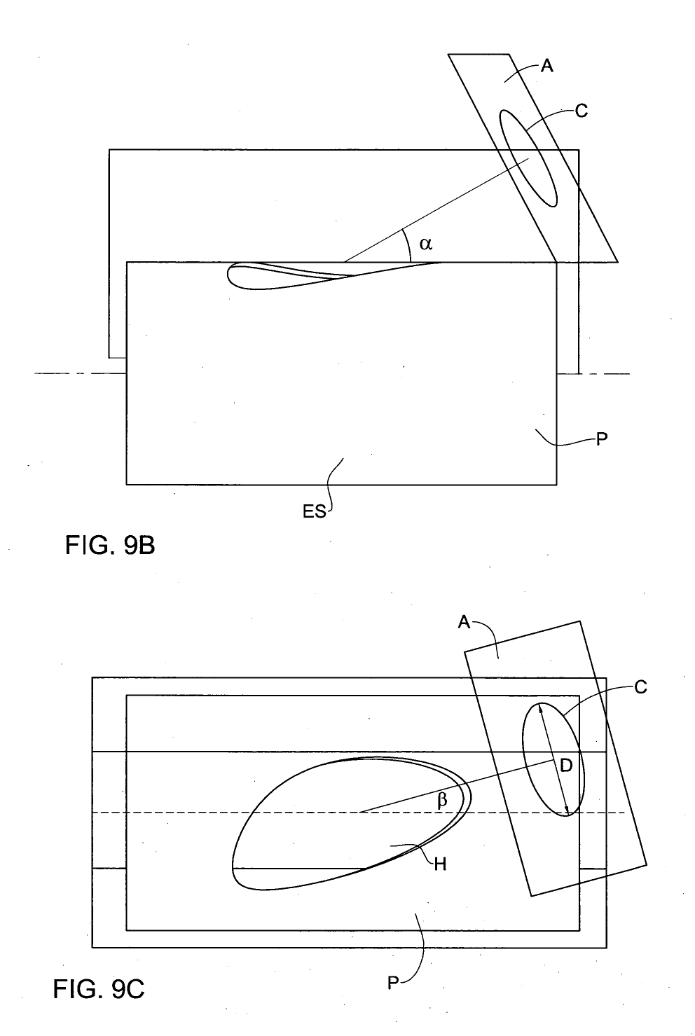

Turning now to FIGS. 9A to 9C, in operation, the CRP system 1 may perform a number of operations including cutting, welding, marking and scanning. For each of the listed operations a different manipulator module 60 may be employed.

The operation of cutting a cut-away H in a pipe P is described.

The pipe P is to be formed with a cut-away H in order to prepare the pipe P for welding thereto of an additional pipe connecting thereto. The additional pipe has a circular cross-section C of diameter D, and is inclined with respect to the pipe P an angle α with respect to the vertical plane and an angle β with respect to the horizontal plane. More particularly, the central axis of the additional pipe lies on a plane which is angled at γ to a horizontal plane tangent to the surface ES of the pipe P. As is apparent from FIGS. 9A to 9C, the shape of the cut-away H is of unique geometric shape and dimensions derived from the size and inclination of the additional pipe.

In order to cut the cut-away along the exact required contour, the manipulator module 60 is required to perform motion in both the axial and circumferential directions. Axial movement is provided by the manipulator motor displacing the manipulator arm 62 within the actuator 66, while circumferential movement is provided by the entire system 1 rotating about the pipe P.

Both the drive motor 100 responsible for rotation and the manipulator motor 110 responsible for axial displacement of the manipulator arm are controlled by the control unit, which in fully interfaced with the control center and a 3D software providing the exact special shape and orientation of the cut-away contour.

It should be understood that once the CRP system 1 is positioned at the desired location and connected to the control center, it is completely and independently operative eliminating the need for intervention of an operator.

Ideally, the biasing unit 30 is tensioned to such an extent so as to provide that the wheels of the units have enough traction on the external surface of the pipe in order to roll thereon without slippage. However, in order to provide that the desired contour is cut out regardless of slippage, the controller is provided with an encoder following a mark on the external surface of the pipe. The encoder is adapted to inform the control unit in case of slippage, wherein the control unit is adapted to respond by correspondingly changing the circumferential and axial displacement to maintain proper cutting of the contour of the cut-away. The encoder may be optic based, laser based etc. The is also provided with an auxiliary wheel to follow the surface of the pipe P together with the CRP system 1.

Internal Operation

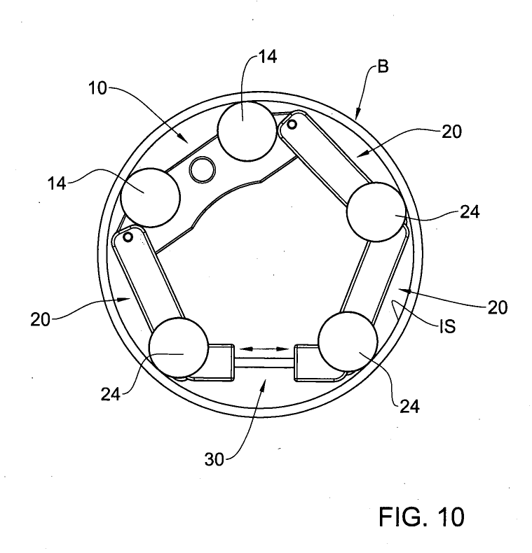

Turning now to FIG. 10 and with further reference to FIG. 5B, the CRP system 1 may also be adapted to be mounted within the pipe P such that the wheels 14, 24 of the drive unit 10 and link unit 20 respectively engage the internal surface IS of the pipe P.

In such case, the biasing unit 30 may be slightly modified by switching the position of the biasing spring 49 from its original position to be disposed between the connecting portion 46 of the projecting rod 44 and the second end of the gear rack 42.

Thus, when mounted into the pipe P, the biasing unit 30 is adapted to expand the entire CRP system 1 such that the wheels 14, 24 apply pressure on the internal surface IS of the pipe P.

Progression Along the Pipe

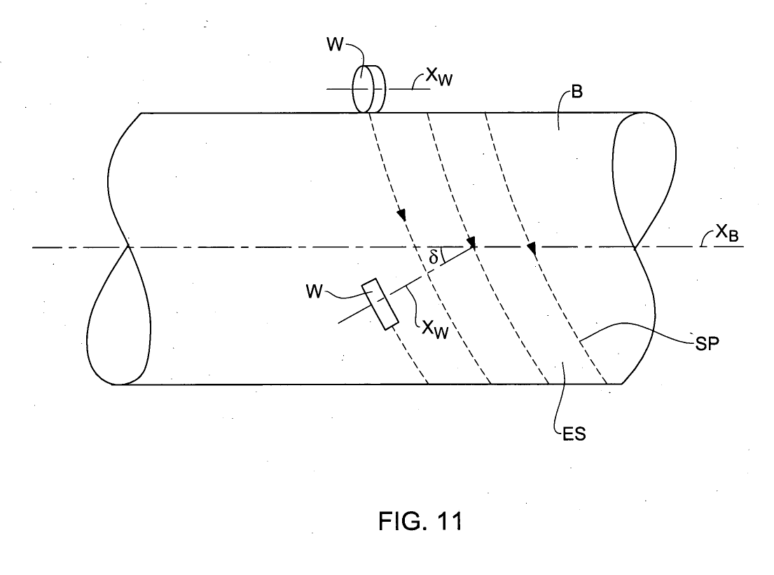

Turning now to FIG. 11, the CRP system 1 is shown with a design allowing the wheels 14, 24 to assume a position in which the central axis X_{w} thereof is angled at δ to the longitudinal axis of the pipe P. Under such an arrangement, rotary motion of the CRP system 1 about the pipe P will entail progression of the CRP system 1 along the pipe P in a spiral path SP.

Such a mode of operation may be particularly useful for operations concerned with maintenance of the entire pipe P, for example painting, anti-corrosive treatment, polishing, coating etc.

Thus, the manipulator arm 62 may be fitted with an appropriate manipulator module 64, for example, a painting module, and progress along the length of the pipe while spraying paint either on the internal surface IS or the external surface ES, depending on the manner of mounting of the CRP system 1 onto the pipe.

It should also be noted that the design of the CRP system is such that provides that the progression is gradual and uniform along the pipe P, allowing application of a uniform layer of paint on the internal or external surface.

Those skilled in the art to which this invention pertains will readily appreciate that numerous changes, variations, and modification can be made without departing from the scope of the invention, mutatis mutandis.

1. Centerless Robotic Platform (CRP) system adapted for mounting on a surface of a body extending along a longitudinal axis, the body having an essentially closed cross-sectional contour, the system comprising:
at least a first drive unit comprising one or more rolling member;
at least one link unit comprising one or more rolling member; and
a biasing arrangement;
wherein the drive unit and the one or more link units are adapted for attachment to one another, and wherein, when mounted onto the body, the biasing arrangement is adapted to bias the rolling members to engage the surface of the body; the biasing arrangement being adapted to urge the rolling members to dynamically follow the contour so as to maintain in surface contact with the surface during rotation of the system about the body.

2. The CRP system according to claim 1, wherein the CRP system further comprises a manipulator assembly comprising:
a manipulator arm;
a replaceable manipulator module adapted to be mounted on the manipulator arm; and
an actuator for imparting movement to the manipulator arm.

3. The CRP system according to claim 2, wherein the manipulator module is adapted to perform any of the following: marking, cutting, welding, inspecting, scanning, painting, and coating.

4. The CRP system according to claim 2, wherein the actuator is adapted to impart a reciprocating motion to the manipulator arm.

5. The CRP system according to claim 2, wherein the actuator is adapted to impart rotary motion to the manipulator arm.

6. The CRP system according to claim 1, wherein the body is a solid body having an external surface.

7. The CRP system according to claim 1, wherein the body is a hollow body having an external and an internal surface.

8. The CRP system according to claim 1, wherein the drive unit comprises a body formed with two sets of rolling members disposed at two ends thereof.

9.-10. (canceled)

11. The CRP system according to claim 2, wherein the drive unit is provided with a controller adapted for regulating the operation of the CRP system.

12. The CRP system according to claim 11, wherein the controller is adapted for regulation of rotary motion of the CRP system about the body, operation of the actuator, and operational modes of the manipulator module.

13.-14. (canceled)

15. The CRP system according to claim 1, wherein the drive unit further comprises a set of attachment ports located at a lead end and a tail end thereof adapted for attaching thereto a link unit and/or the biasing arrangement.

16.-17. (canceled)

18. The CRP system according to claim 1, wherein the biasing arrangement is in the form of a biasing unit.

19.-25. (canceled)

26. The CRP system according to claim 1, wherein the drive unit, one or more link units and the biasing arrangement are modularly connected to one another in an in-line manner to form a chain-like arrangement.

27. The CRP system according to claim 26, wherein any two units are pivotally articulated to one another by a connecting element to have a mutual axis of rotation defined by the connecting element.

28.-30. (canceled)

31. The CRP system according to claim 1, wherein the biasing arrangement provides a dynamic length to the CRP system to allow it to adjust to a variety of round cross-sections of the body as well as irregularities on the surface of the body while still maintaining surface contact with the surface.

32.-35. (canceled)

36. The CRP system according to claim 1, wherein, when mounted onto the body, the rolling members are arranged such that the axis of rotation thereof is inclined with respect to the longitudinal axis, whereby rotary motion of the CRP system about the body entails progression of the CRP system along the body.

37. (canceled)

38. The CRP system according to claim 7, wherein the CRP system is adapted to be mounted on the internal surface of the body.

39.-44. (canceled)

45. The CRP system according to claim 2, wherein the CRP system comprises several manipulator assemblies articulated to different units of the CRP.

46.-49. (canceled)
